(19) United States
(12) Patent Application Publication
(10) Pub. No.: US 2025/0208262 A1
(43) Pub. Date: Jun. 26, 2025

(54) OPTICAL DEFLECTION DEVICE AND DISTANCE MEASUREMENT DEVICE

(71) Applicant: KYOCERA Corporation, Kyoto (JP)

(72) Inventor: Hiroki OKADA, Machida-shi, Tokyo (JP)

(73) Assignee: KYOCERA Corporation, Kyoto (JP)

(21) Appl. No.: 18/849,976

(22) PCT Filed: Mar. 23, 2023
(86) PCT No.: PCT/JP2023/011603

§ 371 Date: Sep. 23, 2024

(30) Foreign Application Priority Data
Mar. 30, 2022 (JP) 2022-057703

(51) Int. Cl. G01S 7/481; G01S 17/08

(52) U.S. Cl. CPC G01S 7/4817; G01S 17/08

(57) ABSTRACT

An optical deflection device includes a first mirror unit, a second mirror unit, and a support unit. The first mirror unit includes a first mirror surface that is a reflection surface that reflects light. The second mirror unit is opposed to the first mirror unit and includes a second mirror surface that is a reflection surface that reflects light. The support unit couples the first mirror unit and the second mirror unit while supporting the first mirror unit and the second mirror unit in a swingable manner about a movable axis. The first mirror surface and the second mirror surface are respectively disposed on surfaces different from surfaces at which the first mirror unit and the second mirror unit are coupled to the support unit.

### CROSS-REFERENCE TO RELATED APPLICATIONS

The present application claims priority to Japanese Patent Application No. 2022-57703 filed on Mar. 30, 2022, which is incorporated herein by reference in its entirety.

### TECHNICAL FIELD

The present disclosure relates to an optical deflection device and a distance measurement device.

### BACKGROUND OF INVENTION

Devices which have been developed in recent years acquire information on surrounding objects based on detection results of electromagnetic waves such as light. For example, a known radar device emits laser light or the like and receives a reflected wave reflected by a given object to measure a distance to the object. Such a device includes an optical deflection device that may adopt a MEMS (micro electro mechanical systems) mirror that is capable of wide-angle scanning and excels in angular resolution capability. For example, Patent Literature 1 discloses a configuration in which a plurality of MEMS mirrors are disposed at a base part on a matrix, and each MEMS mirror is supported to project from the base part. Patent Literature 2 discloses a light deflector in which a piezoelectric actuator swings a plurality of mirrors that deflect laser light, and a support pole supports each of the mirrors to project from a support plate. Patent Literature 3 discloses an optical scanning device that performs scanning with light deflected by a light deflector.

### CITATION LIST

### Patent Literature

Patent Literature 1: Japanese Unexamined Patent Application Publication No. 2016-71145
Patent Literature 2: Japanese Unexamined Patent Application Publication No. 2016-110008
Patent Literature 3: Japanese Unexamined Patent Application Publication No. 2009-210947

### SUMMARY

In an embodiment, an optical deflection device includes a first mirror unit, a second mirror unit, and a support unit. The first mirror unit includes a first mirror surface that is a reflection surface that reflects light. The second mirror unit is opposed to the first mirror unit and includes a second mirror surface that is a reflection surface that reflects light. The support unit couples the first mirror unit and the second mirror unit while supporting the first mirror unit and the second mirror unit in a swingable manner about a movable axis. The first mirror surface and the second mirror surface are respectively disposed on surfaces different from surfaces at which the first mirror unit and the second mirror unit are coupled to the support unit.

In an embodiment, a distance measurement device includes the optical deflection device according to an embodiment described above, a first irradiation unit, a second irradiation unit, a first detection unit, and a second detection unit. The first irradiation unit radiates light to the first mirror unit. The second irradiation unit radiates light to the second mirror unit. The first detection unit receives light deflected by the first mirror unit, reflected on an object, and then reflected on the first mirror unit. The second detection unit receives light deflected by the second mirror unit, reflected on an object, and then reflected on the second mirror unit.

### BRIEF DESCRIPTION OF THE DRAWINGS

FIG. 1 is a view illustrating a schematic configuration of an optical deflection device and a distance measurement device according to a first embodiment.

FIG. 2 is a top view of the optical deflection device according to the first embodiment.

FIG. 3 is a top view where a mirror unit of the optical deflection device is at the center, according to the first embodiment.

FIG. 4 is a block diagram illustrating a functional configuration of the distance measurement device according to the first embodiment.

FIG. 5 is a view illustrating a schematic configuration of a distance measurement device according to a second embodiment.

FIG. 6 is a block diagram illustrating a functional configuration of the distance measurement device according to the first embodiment.

FIG. 7 is a view illustrating a schematic configuration of a variation of the distance measurement device according to the second embodiment.

### DESCRIPTION OF EMBODIMENTS

The optical deflection device, the optical scanning device, or the like as described above is desired to be able to detect a deflection angle of the mirror with favorable precision. The present disclosure provides an optical deflection device that can detect a deflection angle of a mirror with favorable precision, and a distance measurement device including such an optical deflection device. An embodiment can provide an optical deflection device that can detect a deflection angle of a mirror with favorable precision, and a distance measurement device including such an optical deflection device. Hereinafter, an optical deflection device and a distance measurement device according to an embodiment of the present disclosure will be described with reference to the drawings.

### First Embodiment

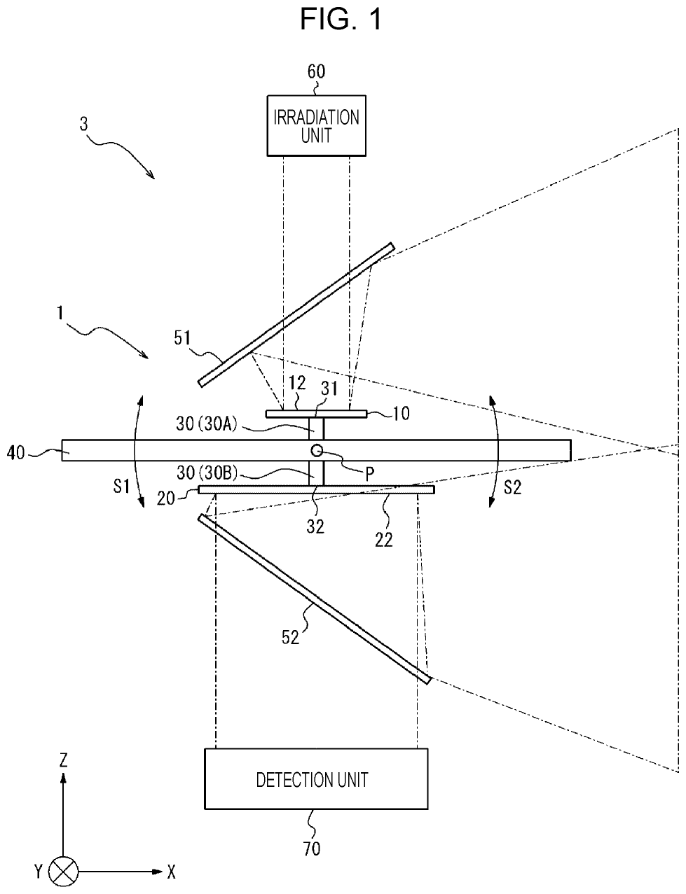

FIGS. 1 to 3 are views illustrating a configuration example of an optical deflection device and a distance measurement device according to a first embodiment.

As illustrated in FIG. 1, an optical deflection device 1 according to the first embodiment includes a first mirror unit 10, a second mirror unit 20, and a support unit 30.

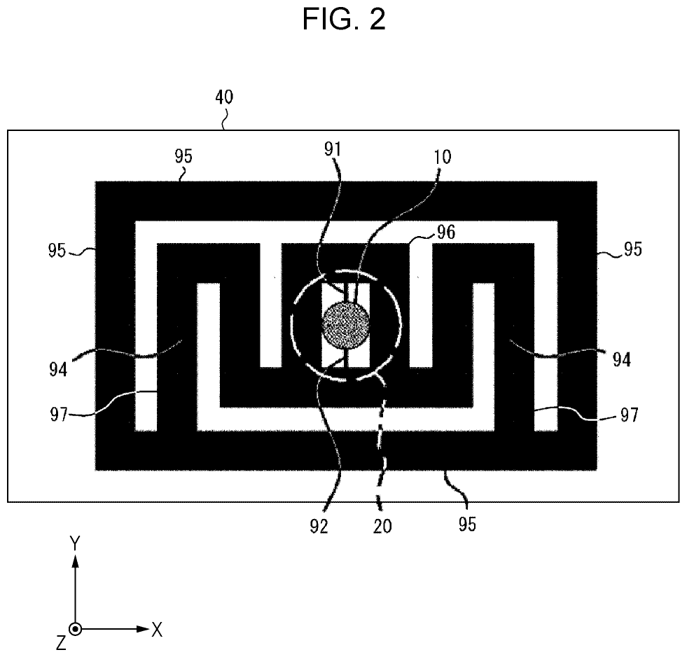

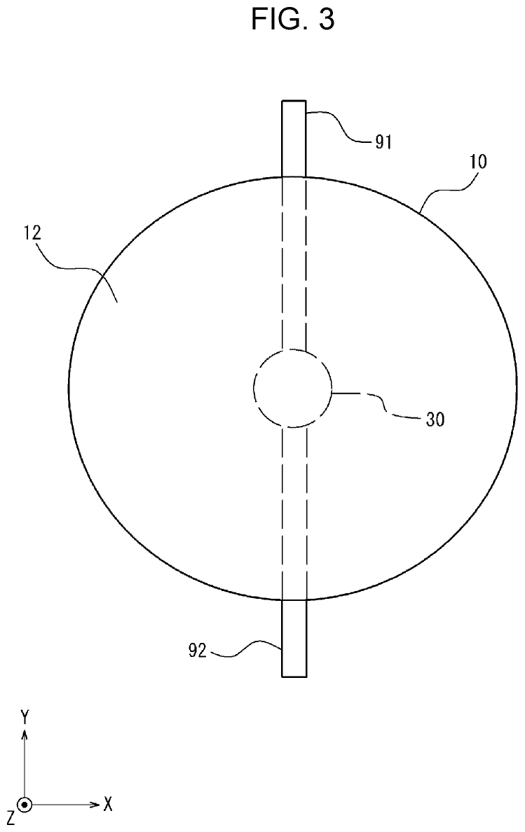

FIG. 1 is a side view in which the optical deflection device 1 is seen from a side (from a view point in a Y-axis positive direction). FIG. 2 is a top view in which a configuration including the first mirror unit 10, a substrate 40, a drive unit 94, a first frame body 95, a second frame body 96, and a connection part 97 in the optical deflection device 1 are seen from above (from a view point in a Z-axis negative direction). FIG. 3 illustrates a partially enlarged view of the configuration of FIG. 2. FIG. 3 is a top view in which the first mirror unit 10, a first torsion bar 91, and a second torsion bar 92 are seen from above (from a view point in the Z-axis negative direction). Herein, the Z-axis direction indicates a direction perpendicular to the substrate 40. The Y-axis direction indicates a direction in which a movable axis P described later extends. An X-axis direction indicates a direction perpendicular to the Y-axis direction.

The first mirror unit 10 may include a first mirror surface 12. The first mirror surface 12 may include, for example, a reflection surface that reflects an electromagnetic wave such as light. The first mirror surface 12 may be disposed in a direction including a component in the Z-axis positive direction with respect to the substrate 40. The first mirror surface 12 reflects, in a direction including a component in the Z-axis positive direction, an electromagnetic wave that travels while including a component in the Z-axis negative direction. The first mirror surface 12 may adopt, for example, an arbitrary surface that is used for a conventional, general MEMS mirror, and reflects an electromagnetic wave such as light. The reflection surface of the first mirror surface 12 may be at least partially flat. The reflection surface of the first mirror surface 12 may be at least partially curved.

The second mirror unit 20 may include a second mirror surface 22. The second mirror surface 22 may include, for example, a reflection surface that reflects an electromagnetic wave such as light. The second mirror surface 22 may be disposed in a direction including a component in the Z-axis negative direction with respect to the substrate 40. The second mirror surface 22 reflects, in a direction including a component in the Z-axis negative direction, an electromagnetic wave that travels while including a component in the Z-axis positive direction. The second mirror surface 22 may adopt, for example, an arbitrary surface that is used for a conventional, general MEMS mirror, and reflects an electromagnetic wave such as light. The reflection surface of the second mirror surface 22 may be at least partially flat. The reflection surface of the second mirror surface 22 may be at least partially curved.

For example, the first mirror unit 10 and/or the second mirror unit 20 may be made of an arbitrary material that is durable for use as a MEMS mirror. For example, the first mirror surface 12 and/or the second mirror surface 22 may be made of an arbitrary material that is durable for use as a MEMS mirror.

Shapes of the first mirror unit 10 and/or the second mirror unit 20 are not particularly limited, but may be any shape. For example, the shapes of the first mirror unit 10 and/or the second mirror unit 20 may be a square shape, a rectangular shape, a parallelogram shape, a polygonal shape, a circular (disk) shape, or the like when seen in the Z-axis direction illustrated in FIG. 1. Shapes of the first mirror surface 12 and/or the second mirror surface 22 are not particularly limited, but may be any shape. For example, the shapes of the first mirror surface 12 and/or the second mirror surface 22 may be a square shape, a rectangular shape, a parallelogram shape, a polygonal shape, a circular (disk) shape, or the like when seen in the Z-axis direction illustrated in FIG. 1.

The support unit 30 has a pole-like shape, and includes a first end 31 and a second end 32. An end portion of the support unit 30 directed in the Z-axis positive direction is denoted by the first end 31, and an end portion of the support unit 30 directed in the Z-axis negative direction is denoted by the second end 32.

The first end 31 of the support unit 30 may be provided with the first mirror unit 10. The second end 32 of the support unit 30 may be provided with the second mirror unit 20. For example, the support unit 30 may be made of an arbitrary material that is durable for supporting the first mirror unit 10 and the second mirror unit 20, such as a MEMS mirror. The support unit 30 may have various shapes without being limited to the shape as illustrated in FIG. 1. The support unit 30 may have an arbitrary shape, such as a cylinder or a prism.

The movable axis P for swinging of the first mirror unit 10 and the second mirror unit 20 is positioned between the first end 31 and the second end 32 of the support unit 30. The movable axis P includes a first torsion bar 91 extending in the Y-axis positive direction, and a second torsion bar 92 extending in the Y-axis negative direction. The first mirror unit 10 and the second mirror unit 20 may swing with the movable axis P functioning as a rotational axis. The support unit 30 supports the first mirror unit 10 and the second mirror unit 20 in a swingable manner about the movable axis P.

For example, the movable axis P may be in parallel to the Y-axis. The support unit 30 may extend in a direction perpendicular to the reflection surface of the first mirror surface 12. The support unit 30 may extend in a direction perpendicular to the reflection surface of the second mirror surface 22. The movable axis P may extend in a direction in parallel to the reflection surface of the first mirror surface 12. The movable axis P may extend in a direction in parallel to the reflection surface of the second mirror surface 22. The first mirror unit 10 and the second mirror unit 20 may swing in directions indicated by arrows S1 and S2 in FIG. 1. The first mirror unit 10 and the second mirror unit 20 may be supported in a swingable manner with respect to the substrate 40 with the support unit 30 interposed therebetween. The substrate 40 may include the movable axis P. The substrate 40 may appropriately include the drive unit 94, a drive circuit, or the like that drives the support unit 30, the first mirror unit 10, and the second mirror unit 20. The drive unit 94 is coupled to the movable axis P, and drives the first mirror unit 10 and the second mirror unit 20. The first mirror unit 10 and the second mirror unit 20 may be driven by a piezoelectric element deforming the drive unit 94, and swing with the movable axis P functioning as the rotational axis. The piezoelectric element is disposed at the drive unit 94. A method for driving the first mirror unit 10 and the second mirror unit 20 is not limited to the method using the piezoelectric element, but an arbitrary method, such as an electrostatic method or an electromagnetic method, may be adopted.

The first mirror unit 10 and the second mirror unit 20 may be positioned to oppose to one another while sandwiching the substrate 40 therebetween. For example, the reflection surface of the first mirror surface 12 and the reflection surface of the second mirror surface 22 may be positioned to face in directions including opposite direction components to one another, such as at the Z-axis positive direction side and at the Z-axis negative direction side relative to the substrate 40.

The support unit 30 includes a first portion 30A and a second portion 30B. The first portion 30A includes the first end 31. The second portion 30B includes the second end 32. The first portion 30A is provided at the Z-axis positive direction side from the movable axis P. The second portion 30B is provided at the Z-axis negative direction side from the movable axis P.

For example, the first mirror unit 10 may project perpendicularly from the given movable axis P, and be coupled to the first portion 30A. For example, the second mirror unit 20 may project perpendicularly from the given movable axis P, and be coupled to the second portion 30B.

The first mirror unit 10 and the second mirror unit 20 are coupled to the support unit 30, and thereby deflection angles of the first mirror unit 10 and the second mirror unit 20 interlock with the one another. Absolute values of the deflection angles of the first mirror unit 10 and the second mirror unit 20 may match with one another.

The first mirror unit 10 and the second mirror unit 20 may be disposed in parallel to one another. The first mirror unit 10 and the second mirror unit 20 may be disposed in nonparallel to one another.

As illustrated in FIG. 3, the first torsion bar 91 and the second torsion bar 92 are coupled to the support unit 30 that supports the first mirror unit 10. In FIG. 3, a portion hidden by the first mirror unit 10 is illustrated by a broken line.

As illustrated in FIG. 2, the drive unit 94 includes the second frame body 96 and the connection part 97. The second frame body 96 has in a quadrangular shape and surrounds the support unit 30. The connection part 97 connects the second frame body 96 to the first frame body 95. The connection part 97 may have a bending shape with multiple turns. The first torsion bar 91 and the second torsion bar 92 are coupled to the second frame body 96 of the drive unit 94. The first torsion bar 91 and the second torsion bar 92 are coupled to opposite sides of the second frame body 96 of the drive unit 94. The first mirror unit 10 is coupled to the first end 31 of the support unit 30, and thereby coupled to the drive unit 94 with the first torsion bar 91 and the second torsion bar 92 interposed therebetween. The second mirror unit 20 is coupled to the second end 32 of the support unit 30, and thereby coupled to the drive unit 94 with the first torsion bar 91 and the second torsion bar 92 interposed therebetween.

A piezoelectric element is provided to the connection part 97. The first torsion bar 91 and the second torsion bar 92 support the support unit 30 in a swingable manner. The support unit 30 supports the first mirror unit 10 at the first end 31. The support unit 30 supports the second mirror unit 20 at the second end 32. The support unit 30 swings about an axis of the first torsion bar 91 and the second torsion bar 92, and thereby the first mirror unit 10 and the second mirror unit 20 swing. The piezoelectric element causes flexure to at least the connection part 97, and thereby the first mirror unit 10 and the second mirror unit 20 swing. For example, the first frame body 95 may be fixed to the substrate 40.

The distance measurement device 3 may appropriately include an irradiation unit 60 and a detection unit 70 in addition to the optical deflection device 1 described above. For example, the irradiation unit 60 may include a light source that outputs an electromagnetic wave such as laser light. Examples the light source include a laser diode. The detection unit 70 may include a functional part that detects light entering the distance measurement device 3. Examples of the functional part that detects light include a photodiode.

The detection unit 70 may include an avalanche photodiode that is a photodiode whose light-receiving sensitivity is increased via avalanche multiplication.

The first mirror unit 10 may reflect light radiated from the irradiation unit 60, and exit the reflected light outward from the optical deflection device 1. The first mirror unit 10 may reflect light radiated from the irradiation unit 60. For example, the first mirror unit 10 may reflect light radiated from the irradiation unit 60, and output the reflected light outside of the optical deflection device 1.

The distance measurement device 3 may include a first fixed mirror 51. The first fixed mirror 51 may be disposed to have a tilt with respect to the reflection surface of the first mirror unit 10. The first fixed mirror 51 can reflect light radiated from the irradiation unit 60, and/or light reflected by the first mirror unit 10. The first fixed mirror 51 may be a half mirror. For example, the first fixed mirror 51 may transmit part of light radiated from the irradiation unit 60, and reflect part of light reflected on the first mirror unit 10.

The second mirror unit 20 may reflect light to be received by the optical deflection device 1. The second mirror unit 20 may reflect light to be taken in toward the detection unit 70 from outside of the optical deflection device 1. The second mirror unit 20 may reflect light to be detected by the detection unit 70. For example, the second mirror unit 20 may reflect, toward the detection unit 70, light to be taken in from outside of the optical deflection device 1.

The distance measurement device 3 may include a second fixed mirror 52. The second fixed mirror 52 may be disposed to have a tilt with respect to the reflection surface of the second mirror unit 20. The second fixed mirror 52 can reflect light to be taken in from outside of the optical deflection device 1, and/or light reflected by the second mirror unit 20. The second fixed mirror 52 may be a half mirror. For example, the second fixed mirror 52 may reflect part of light to be taken in from outside of the optical deflection device 1, and transmit part of light reflected on the second mirror unit 20.

The distance measurement device 3 may appropriately include the drive unit 94 or a drive circuit that drives the optical deflection device 1, a housing, and a lid. Illustration of these members is omitted.

Light radiated by the irradiation unit 60 may reflect on the first mirror unit 10, and scan space outside of the distance measurement device 3. The light reflected on the first mirror unit 10 may reflect on the first fixed mirror 51, and irradiate an object. Reflected light that is radiated and reflected on the object enters the distance measurement device 3. The reflected light that enters the distance measurement device 3 reflects on the second fixed mirror 52, and is guided to the second mirror unit 20. The light guided to the second mirror unit 20 may reflect on the second mirror unit 20, and enter the detection unit 70. The detection unit 70 may detect the reflected light reflected on the object. The detection unit 70 may measure a distance to the object based on the detected light.

The first mirror unit 10 and the second mirror unit 20 may be made of the same reflective material. The first mirror unit 10 and the second mirror unit 20 may include reflective materials different from one another.

Mirrors of the first mirror unit 10 and the second mirror unit 20 may have the same diameter, area, and shape as one another. The mirrors of the first mirror unit 10 and the second mirror unit 20 may have different diameters, areas, and shapes from one another.

An area of the reflection surface of the first mirror unit 10 may be the same as an area of the reflection surface of the second mirror unit 20. The area of the reflection surface of the first mirror unit 10 may be different from the area of the reflection surface of the second mirror unit 20. The area of the reflection surface of the second mirror unit 20 may be larger than the area of the reflection surface of the first mirror unit 10. The reflection surface of the second mirror unit 20 larger than the reflection surface of the first mirror unit 10 can acquire more reflected light, and more reflected light enters the detection unit 70. Therefore, the detection unit 70 has improved sensitivity.

Mass of the first mirror unit 10 may be the same as mass of the second mirror unit 20. The mass of the first mirror unit 10 may be different from the mass of the second mirror unit 20. The mass of the second mirror unit 20 may be larger than the mass of the first mirror unit 10. The second mirror unit 20 having the larger mass and/or area than those of the first mirror unit 10 allows to maintain a state in which a resonance frequency of the first mirror unit 10 and the second mirror unit 20 does not decrease excessively. A frame rate in scanning by the light reflected from the first mirror unit 10 is comparatively high.

The given movable axis P may be an unsubstantial, imaginary axis. For example, the given movable axis P may be a substantial axis such as the first torsion bar 91 and/or the second torsion bar 92. The method for driving the first mirror unit 10 and the second mirror unit 20 may be an arbitrary method, such as a piezoelectric method, an electrostatic method, or an electromagnetic method. An aspect of driving the first mirror unit 10 and the second mirror unit 20 may be one-axis drive including only the movable axis P. The aspect of driving the first mirror unit 10 and the second mirror unit 20 may be two or more-axes drive including another movable axis in addition to the movable axis P.

The optical deflection device 1 may include the first mirror unit 10, the second mirror unit 20, and the support unit 30. The first mirror unit 10 includes the first mirror surface 12. The first mirror surface 12 is the reflection surface that reflects light. The second mirror unit 20 is opposed to the first mirror unit 10, and includes the second mirror surface 22. The second mirror surface 22 is the reflection surface that reflects light. The support unit 30 couples the first mirror unit 10 and the second mirror unit 20 while supporting the first mirror unit 10 and the second mirror unit 20 in a swingable manner about the movable axis P. The first mirror surface 12 and the second mirror surface 22 may respectively be disposed on surfaces different from surfaces where the first mirror unit 10 and the second mirror unit 20 are coupled to the support unit 30.

In the above-described aspect, the optical deflection device 1 includes only one first mirror unit 10 and one second mirror unit 20 to simplify the description. The optical deflection device 1 may include two or more first mirror units 10 and two or more second mirror units 20. The optical deflection device 1 may include a mirror array including a plurality of first mirror units 10, and a mirror array including a plurality of second mirror units 20.

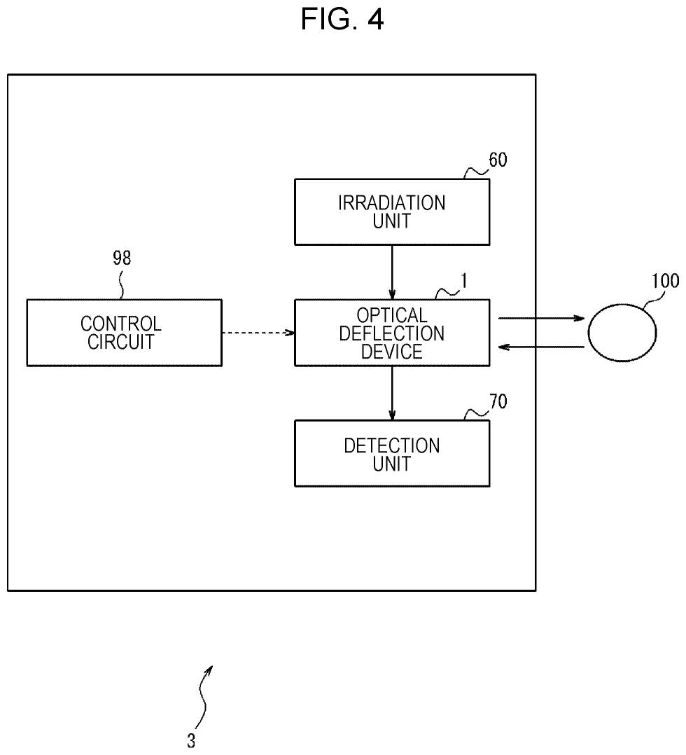

FIG. 4 is a block diagram illustrating a functional configuration of the distance measurement device 3 including the optical deflection device 1 according to the first embodiment. Below, the distance measurement device 3 according to an embodiment is described.

As illustrated in FIG. 4, the distance measurement device 3 according to an embodiment includes the optical deflection device 1 described above. The distance measurement device 3 includes the irradiation unit 60 and the detection unit 70. The distance measurement device 3 may include a control circuit 98.

For example, the irradiation unit 60 outputs an electromagnetic wave such as an infrared light beam. The optical deflection device 1 deflects at least part of the electromagnetic wave outputted by the irradiation unit 60. At least part of a reflected wave, which is obtained by the electromagnetic wave deflected by the optical deflection device 1 reflecting on an object 100, for example, enters the detection unit 70. The control circuit 98 may control driving of the detection unit 70 described above. The distance measurement device 3 may measure a distance to the object 100 based on an output timing of the electromagnetic wave outputted by the irradiation unit 60, and an enter timing at which the reflected wave enters the detection unit 70.

### Second Embodiment

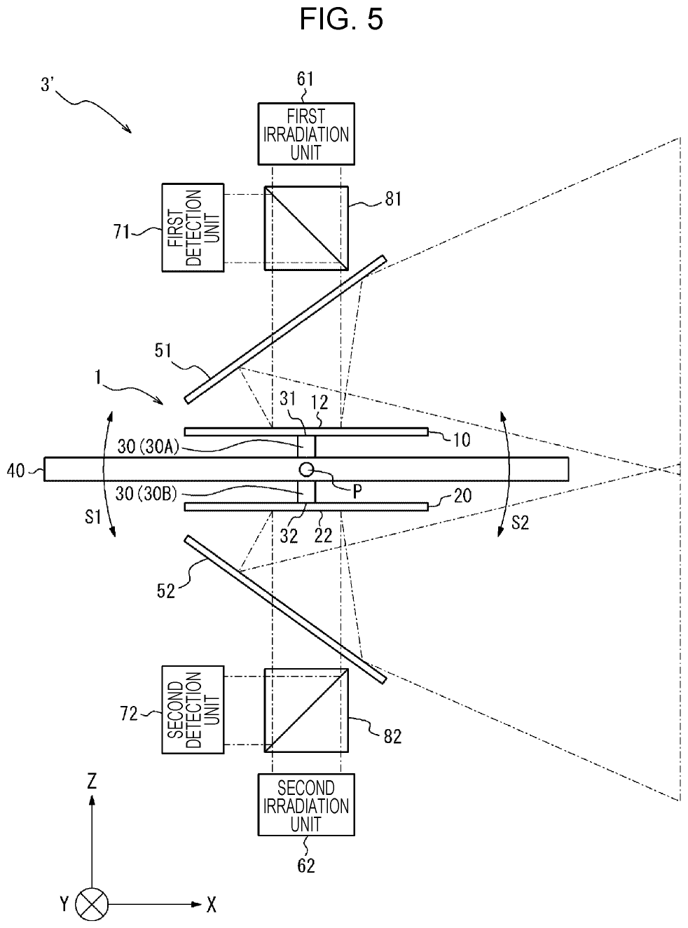

FIG. 5 is a view illustrating a configuration example of a distance measurement device according to a second embodiment. Below, an optical deflection device according to the second embodiment is described.

A distance measurement device 3′ illustrated in FIG. 5 may include a portion the same as and/or similar to the distance measurement device 3. With respect to the distance measurement device 3′ according to the second embodiment, description of contents the same as or similar to the distance measurement device 3 may appropriately be simplified or omitted.

The distance measurement device 3′ may include a first irradiation unit 61, a first detection unit 71, and a first prism 81 at the first mirror unit 10 side. The distance measurement device 3′ may include a second irradiation unit 62, a second detection unit 72, and a second prism 82 at the second mirror unit 20 side.

The first prism 81 and the second prism 82 may transmit light entering thereinto from a given direction, and reflect light entering thereinto from a direction different from the given direction. The first prism 81 and the second prism 82 may be a beam splitter.

The first mirror unit 10 may reflect, outward from the optical deflection device 1, light that enters from the first irradiation unit 61. The first mirror unit 10 may reflect the light radiated from the first irradiation unit 61. For example, the first mirror unit 10 may reflect the light radiated from the first irradiation unit 61, and output it outside of the optical deflection device 1. The first mirror unit 10 may reflect light that enters the optical deflection device 1. The first mirror unit 10 may reflect light to be detected by the first detection unit 71. The first mirror unit 10 may reflect, toward the first prism 81, light to be taken in from outside of the optical deflection device 1.

The second mirror unit 20 may reflect, outward from the optical deflection device 1, light that enters from the second irradiation unit 62. The second mirror unit 20 may reflect the light radiated from the second irradiation unit 62. For example, the second mirror unit 20 may reflect the light radiated from the second irradiation unit 62, and output it outside of the optical deflection device 1. The second mirror unit 20 may reflect light that enters the optical deflection device 1. The second mirror unit 20 may reflect light to be detected by the second detection unit 72. The second mirror unit 20 may reflect, toward the second prism 82, light to be taken in from outside of the optical deflection device 1.

The first mirror unit 10 and the second mirror unit 20 may have the same area, mass, and/or the like, as one another. The first mirror unit 10 and the second mirror unit 20 may have different areas, mass, and/or the like, from one another.

The first mirror unit 10 and the second mirror unit 20 may have the same optical characteristics as one another. The first mirror unit 10 and the second mirror unit 20 may have different optical characteristics from one another. Mirrors of the first mirror unit 10 and the second mirror unit 20 may have different wavelengths and/or deflection directions of the reflected light from one another, thus performing scanning and detection with different characteristics.

The optical characteristics of the first mirror unit 10 and the second mirror unit 20 can include various characteristics. Examples of the optical characteristics include reflection characteristics including reflectance. The first mirror unit 10 and the second mirror unit 20 may have different reflectance for an electromagnetic wave with a certain wavelength. The first mirror unit 10 or the second mirror unit 20 may have higher reflectance for light with a wavelength of 905 nm compared to light with another wavelength. The first mirror unit 10 or the second mirror unit 20 may have higher reflectance for light with a wavelength of 1550 nm compared to light with another wavelength. The first mirror unit 10 and the second mirror unit 20 having different optical characteristics can reduce entering of light with a wavelength other than the certain wavelength into the first detection unit 71 and the second detection unit 72. Thereby, the first detection unit 71 and the second detection unit 72 can have improved sensitivity.

For example, the first irradiation unit 61 radiates an electromagnetic wave with a wavelength of 905 nm, and the second irradiation unit 62 radiates an electromagnetic wave with a wavelength of 1550 nm. The first mirror unit 10 has higher reflectance for an electromagnetic wave with a wavelength of 905 nm compared to the second mirror unit 20. The second mirror unit 20 has higher reflectance for an electromagnetic wave with a wavelength of 1550 nm compared to the first mirror unit 10. In this case, an electromagnetic wave with a wavelength of 1550 nm is less likely to enter the first detection unit 71. The same and/or similarly, an electromagnetic wave with a wavelength of 905 nm is less likely to enter the second detection unit 72. That is, the first detection unit 71 and the second detection unit 72 can have reduced noise entering thereinto.

By the first irradiation unit 61 and the second irradiation unit 62 radiating electromagnetic waves with different wavelengths, distance measurement for an object having low reflectance for an electromagnetic wave radiated from the first irradiation unit 61 can be performed by using an electromagnetic wave radiated from the second irradiation unit 62. In other words, depending on an object of a distance-measurement target, a corresponding wavelength of an electromagnetic wave can be used. The first irradiation unit 61 and the second irradiation unit 62 may radiate electromagnetic waves toward the same position, and then the distance measurement device 3′ may measure a distance to an object based on a detection result of the first detection unit 71 or the second detection unit 72 that detects more of reflected waves of the radiated electromagnetic waves.

The first fixed mirror 51 can reflect light reflected by the first mirror unit 10. For example, the first fixed mirror 51 may transmit part of light radiated from the first irradiation unit 61, and reflect part of light reflected on the first mirror unit 10. For example, the first fixed mirror 51 may reflect, toward the first mirror unit 10, light to be taken in from outside of the distance measurement device 3′, and transmit light reflected on the first mirror unit 10.

The second fixed mirror 52 can reflect light reflected by the second mirror unit 20. For example, the second fixed mirror 52 may transmit part of light radiated from the second irradiation unit 62, and reflect part of light reflected on the second mirror unit 20. For example, the second fixed mirror 52 may reflect, toward the second mirror unit 20, light to be taken in from outside of the distance measurement device 3′, and transmit light reflected on the second mirror unit 20.

The distance measurement device 3′ may adjust an installation angle of the first fixed mirror 51 so that light beams for scanning by the first fixed mirror 51 and the second fixed mirror 52 are directed in the same direction. The distance measurement device 3′ may adjust an installation angle of the second fixed mirror 52 so that light beams for scanning by the first fixed mirror 51 and the second fixed mirror 52 are directed in the same direction.

The first irradiation unit 61 may radiate light that is to be at least partially deflected by the first mirror unit 10. The second irradiation unit 62 may radiate light that is to be at least partially deflected by the second mirror unit 20.

The first detection unit 71 may detect light reflected by the first mirror unit 10. The second detection unit 72 may detect light reflected by the second mirror unit 20.

Part of light radiated by the first irradiation unit 61 is transmitted through the first prism 81 and the first fixed mirror 51, and reflected on the first mirror unit 10. The light reflected on the first mirror unit 10 may reflect on the first fixed mirror 51, and irradiate an object existing in space outside of the distance measurement device 3′. Reflected light that is radiated and reflected on the object enters the distance measurement device 3′. The reflected light that enters the distance measurement device 3′ reflects on the first fixed mirror 51, and is guided to the first mirror unit 10. The light guided to the first mirror unit 10 is reflected on the first mirror unit 10, transmitted through the first fixed mirror 51, and guided to the first prism 81. The light guided to the first prism 81 may reflect on the first prism 81, and enter the first detection unit 71. The first detection unit 71 may detect the reflected light reflected on the object. The first detection unit 71 may measure a distance to the object based on the detected light.

Light radiated by the second irradiation unit 62 is transmitted through the second prism 82 and the second fixed mirror 52, and reflected on the second mirror unit 20. The light reflected on the second mirror unit 20 may reflect on the second fixed mirror 52, and irradiate an object existing in space outside of the distance measurement device 3′. Reflected light that is radiated and reflected on the object enters the distance measurement device 3′. The reflected light that enters the distance measurement device 3′ reflects on the second fixed mirror 52, and is guided to the second mirror unit 20. The light guided to the second mirror unit 20 is reflected on the second mirror unit 20, transmitted through the second fixed mirror 52, and guided to the second prism 82. The light guided to the second prism 82 may reflect on the second prism 82, and enter the second detection unit 72. The second detection unit 72 may detect the reflected light reflected on the object. The second detection unit 72 may measure a distance to the object based on the detected light.

In the distance measurement device 3′ illustrated in FIG. 5, a third detection unit (not illustrated) may be disposed at a position where an electromagnetic wave radiated from the second irradiation unit 62 and reflected on the second mirror unit 20 enters. The second irradiation unit 62 may radiate pulsed light, or may radiate continuous light. The third detection unit may be a single detection unit element, or multiple detection elements disposed to be separate from one another. The third detection unit is disposed at a position where an electromagnetic wave reflected on the second mirror unit 20 enters the third detection unit when the second mirror unit 20 has a given angle determined in advance. The control circuit 98 can calculate a deflection angle of the second mirror unit 20 based on a timing at which the electromagnetic wave reflected on the second mirror unit 20 enters the third detection unit. The first mirror unit 10 and the second mirror unit 20 are coupled to one another with the support unit 30 interposed therebetween. Therefore, a deflection angle of the first mirror unit 10 can be calculated based on the deflection angle of the second mirror unit 20.

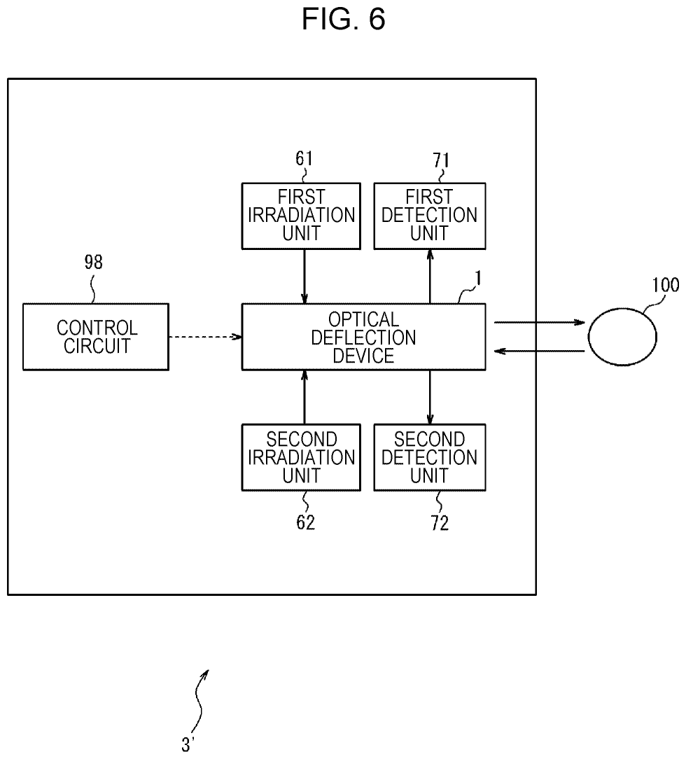

FIG. 6 is a block diagram illustrating a functional configuration of the distance measurement device 3′ according to the second embodiment. Below, the distance measurement device 3′ according to an embodiment is described.

As illustrated in FIG. 6, the distance measurement device 3′ includes the optical deflection device 1 described above. The distance measurement device 3′ includes the first irradiation unit 61 and the first detection unit 71. The distance measurement device 3′ includes the second irradiation unit 62 and the second detection unit 72. The distance measurement device 3′ may include the control circuit 98.

For example, the first irradiation unit 61 outputs an electromagnetic wave such as an infrared light beam. The optical deflection device 1 deflects at least part of the electromagnetic wave outputted by the first irradiation unit 61. At least part of a reflected wave, which is obtained by the electromagnetic wave deflected by the optical deflection device 1 reflecting on an object 100, for example, enters the first detection unit 71. The control circuit 98 may control driving of the first detection unit 71 described above. The distance measurement device 3′ may measure a distance to the object 100 based on an output timing of the electromagnetic wave outputted by the first irradiation unit 61, and an enter timing at which the reflected wave enters the first detection unit 71.

For example, the second irradiation unit 62 outputs an electromagnetic wave such as an infrared light beam. The optical deflection device 1 deflects at least part of the electromagnetic wave outputted by the second irradiation unit 62. At least part of a reflected wave, which is obtained by the electromagnetic wave deflected by the optical deflection device 1 reflecting on an object 100, for example, enters the second detection unit 72. The control circuit 98 may control driving of the second detection unit 72 described above. The distance measurement device 3′ may measure a distance to the object 100 based on an output timing of the electromagnetic wave outputted by the second irradiation unit 62, and an enter timing at which the reflected wave enters the second detection unit 72.

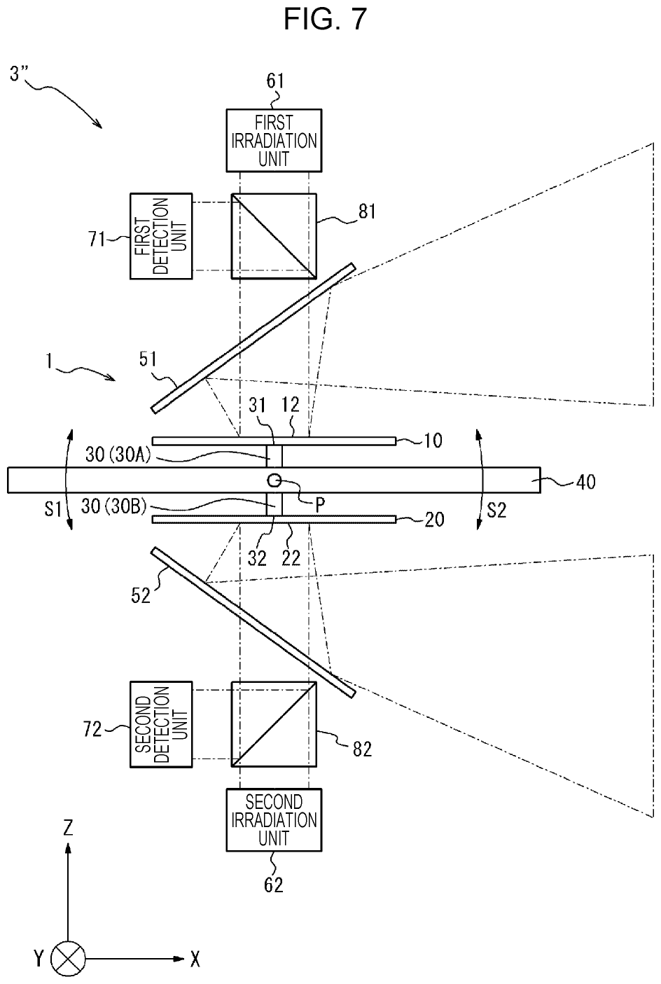

FIG. 7 is a view illustrating a configuration example of a variation of the distance measurement device according to the second embodiment.

A distance measurement device 3″ illustrated in FIG. 7 may include a portion the same as and/or similar to the distance measurement device 3′ illustrated in FIG. 5. With respect to the distance measurement device 3″ according the variation of the second embodiment, description of contents the same as or similar to the distance measurement device 3′ may appropriately be simplified or omitted.

The distance measurement device 3″ may be the distance measurement device 3′ in which an installation angle of the first fixed mirror 51, the second fixed mirror 52, and/or the like are changed. In the distance measurement device 3″, an angle of view of a light beam that scans via the first fixed mirror 51, and an angle of view of a light beam that scans via the second fixed mirror 52 may be different from one another. In the distance measurement device 3″, an angle of view of a light beam for scanning may increase.

Although representative examples have been described in the above embodiments, it is obvious to those skilled in the art that many changes and substitutions can be made within the gist and the scope of the present disclosure. Thus, the present disclosure should not be considered to be limited to the above-described embodiments, and variations and various changes can be made without departing from the scope of the claims. For example, multiple configuration blocks illustrated in the configuration diagrams of the embodiments can be combined into a single configuration block, or one configuration block may be divided into multiple configuration blocks.

In each embodiment described above, for example, various mirrors such as the first fixed mirror 51 and/or the second fixed mirror 52 may reflect light. In such a configuration, as described above, for example in the distance measurement device 3′ illustrated in FIG. 2, the respective light beams for scanning can be directed in the same direction. In this case, the first mirror unit 10 and the second mirror unit 20 may have the same phase, or may have opposite phases. Such a change in the phase may be implemented by each of various mirrors that are operated to reflect light beams.

In various configurations illustrated in FIGS. 1 to 3, for example, a bandpass filter that allows only light with a given wavelength to pass therethrough may appropriately be installed.

For example, each embodiment described above may be implemented as a scanning device including the optical deflection device 1. In this case, for example, the first mirror unit 10 may reflect light to be radiated from the optical deflection device 1. The second mirror unit 20 may reflect light to be received by the optical deflection device 1.

### REFERENCE SIGNS

1 optical deflection device
3, 3′, 3″ distance measurement device
10 first mirror unit
12 first mirror surface
20 second mirror unit
22 second mirror surface
30 support unit
30A first portion
30B second portion
31 first end
32 second end
40 substrate
51 first fixed mirror
52 second fixed mirror
60 irradiation unit
61 first irradiation unit
62 second irradiation unit
70 detection unit
71 first detection unit
72 second detection unit
81 first prism
82 second prism
91 first torsion bar
92 second torsion bar
94 drive unit
95 first frame body
96 second frame body
97 connection part
100 object
P movable axis

1. An optical deflection device comprising:
a first mirror unit comprising a first mirror surface, the first mirror surface being a reflection surface configured to reflect light;
a second mirror unit opposed to the first mirror unit and comprising a second mirror surface, the second mirror surface being a reflection surface configured to reflect light; and
a support unit configured to couple the first mirror unit and the second mirror unit while supporting the first mirror unit and the second mirror unit in a swingable manner about a movable axis, wherein
the first mirror surface and the second mirror surface are respectively disposed on surfaces different from surfaces at which the first mirror unit and the second mirror unit are coupled to the support unit.

2. The optical deflection device according to claim 1, wherein the support unit comprises a first portion and a second portion projecting from the movable axis,
the first portion is coupled to the first mirror unit, and
the second portion is coupled to the second mirror unit.

3. A distance measurement device comprising:
the optical deflection device according to claim 1;
an irradiation unit configured to radiate light to the first mirror unit; and
a detection unit configured to receive light deflected by the first mirror unit, reflected on an object, and then reflected on the second mirror unit.

4. The distance measurement device according to claim 3, wherein an area of the second mirror unit is larger than an area of the first mirror unit.

5. A distance measurement device comprising:
the optical deflection device according to claim 1;
a first irradiation unit configured to radiate light to the first mirror unit;
a second irradiation unit configured to radiate light to the second mirror unit;
a first detection unit configured to receive light deflected by the first mirror unit, reflected on an object, and then reflected on the first mirror unit; and
a second detection unit configured to receive light deflected by the second mirror unit, reflected on an object, and then reflected on the second mirror unit.

6. The distance measurement device according to claim 5, wherein the first mirror unit and the second mirror unit comprise reflective materials different from one another.

7. The distance measurement device according to claim 5, wherein the first mirror unit and the second mirror unit have optical characteristics different from one another.

8. The distance measurement device according to claim 5, wherein the first detection unit detects at least part of light deflected by the first mirror unit and then reflected by an object, and measures a distance to the object.

9. The distance measurement device according to claim 5, wherein the second detection unit detects a deflection angle of the first mirror unit based on detected light.
